(19) United States
(12) Patent Application Publication
(10) Pub. No.: US 2026/0233975 A1
(43) Pub. Date: Aug. 13, 2026

(54) CAR DOOR INTERLOCK

(71) Applicant: OTIS ELEVATOR COMPANY, Farmington, CT (US)

(72) Inventor: Michael J. Tracey, Cromwell, CT (US)

(21) Appl. No.: 19/049,271

(22) Filed: Feb. 10, 2025

(51) Int. Cl. B66B 13/12; B66B 13/20

(52) U.S. Cl. CPC B66B 13/12; B66B 13/20

(57) ABSTRACT

An elevator car door interlock includes a forward vane extending in a vertical direction, a rearward vane spaced axially aft from the forward vane in a horizontal direction, a first linkage assembly coupling the forward vane and rearward vane together, and a second linkage assembly coupling the forward vane and rearward vane together. The second linkage assembly is axially spaced from the first linkage assembly in the vertical direction. A latch assembly has a door latch that is coupled to the first linkage assembly. A switch is positioned forward of the forward vane in the horizontal direction and faces downward in the vertical direction. A switch contact is supported by the door latch to engage the switch in a locked position and disengage from the switch in an unlocked position.

### BACKGROUND

Elevator systems are in widespread use for carrying passengers between various levels in buildings, for example. Access to an elevator car requires that elevator car doors open when the car is at a landing at which a passenger desires to board the elevator car. Each landing includes hoistway doors that move with the elevator car doors between open and closed positions.

Elevator systems include coupler and interlock arrangements for coupling the elevator car doors to the hoistway doors so that an actuator that causes movement of the car doors also causes desired movement of the hoistway doors. The doors should have coordinated movement such that the doors do not start opening movement pre-maturely.

### SUMMARY

An illustrative example elevator car door interlock includes: a forward vane extending in a vertical direction; a rearward vane spaced axially aft from the forward vane in a horizontal direction; a first linkage assembly coupling the forward vane and rearward vane together; a second linkage assembly coupling the forward vane and rearward vane together, wherein the second linkage assembly is axially spaced from the first linkage assembly in the vertical direction; a latch assembly having a door latch that is coupled to the first linkage assembly; a switch positioned forward of the forward vane in the horizontal direction and facing downward in the vertical direction; and a switch contact supported by the door latch to engage the switch in a locked position and disengage from the switch in an unlocked position.

In addition to one or more of the features described herein, or as an alternative, the forward vane and the rearward vane comprise a sensing mechanism that interacts with a set of rollers associated with a landing door interlock to detect when an elevator car is within a door landing zone.

In addition to one or more of the features described herein, or as an alternative, the set of rollers are supported by a bracket assembly that is fixed at an associated landing door and comprise a fixed interlock roller and an interlock unlocking roller, and wherein the elevator car is detected in the door landing zone in response to interaction between the rearward vane and the interlock unlocking roller.

In addition to one or more of the features described herein, or as an alternative, the fixed interlock roller is axially spaced forward from the interlock unlocking roller in the horizontal direction.

In addition to one or more of the features described herein, or as an alternative, the rearward vane defines a first slot and a second slot that are spaced apart from each other in the vertical direction, and wherein the first linkage assembly includes a first intermediate link and a first link, wherein: the first intermediate link is movably connected to the rearward vane through a first pivot pin that extends into the rearward vane and a first pin that extends into the first slot; and the first pin facilitates the first intermediate link moving along the horizontal direction between a rearward slot end and a forward slot end of the first slot, and facilitates pivoting of the first intermediate link relative to the rearward vane.

In addition to one or more of the features described herein, or as an alternative, the first link extends between the first intermediate link and the forward vane, wherein the first link includes a first arm and a second arm, and wherein: the first arm is pivotally connected to the first intermediate link through a first arm pivot; and the second arm is pivotally connected to the forward vane at a first connection and is operably connected to a belt drive.

In addition to one or more of the features described herein, or as an alternative, the second linkage assembly includes a second intermediate link and a second link, and wherein the second intermediate link is movably connected to the rearward vane through a second pivot pin and a second pin, and wherein: the second pivot pin extends into the rearward vane; the second pin extends into the second slot; and the second pin facilitates the second intermediate link moving along the horizontal direction between a rearward slot end and a forward slot end of the second slot, and facilitates pivoting of the second intermediate link relative to the rearward vane.

In addition to one or more of the features described herein, or as an alternative, the second link extends between the second intermediate link and the forward vane, and wherein the second link includes a first arm and a second arm, and wherein: the first arm is pivotally connected to the second intermediate link; the second arm is pivotally connected to the forward vane.

In addition to one or more of the features described herein, or as an alternative, the latch assembly includes a lock member, the door latch, and a latch link, and wherein: the lock member interfaces with the door latch to inhibit elevator car doors from moving from a closed position towards an open position; and the lock member includes the switch which is configured to: provide a signal indicative of the elevator car doors being in the closed position, while the door latch engages the lock member; and provide a signal indicative of the elevator car doors being in an open or unlocked position, while the door latch is disengaged from the lock member.

In addition to one or more of the features described herein, or as an alternative, the latch link extends between the door latch and the first linkage assembly.

An illustrative example interlock assembly includes: a landing door interlock including a set of rollers are supported by a bracket assembly that is fixed at an associated landing door; elevator car door interlock including: a forward vane mounted for movement with an elevator car and extending in a vertical direction; a rearward vane spaced axially aft from the forward vane in a horizontal direction; a first linkage assembly coupling the forward vane and rearward vane together; a second linkage assembly coupling the forward vane and rearward vane together, wherein the second linkage assembly is axially spaced from the first linkage assembly in the vertical direction; a latch assembly having a door latch that is coupled to the first linkage assembly; a switch positioned forward of the forward vane in the horizontal direction and facing downward in the vertical direction; and a switch contact supported by the door latch to engage the switch in a locked position and disengage from the switch in an unlocked position; and wherein the forward vane and the rearward vane comprise a sensing mechanism that interacts with the set of rollers to detect when an elevator car is within a door landing zone.

In addition to one or more of the features described herein, or as an alternative, the set of rollers comprise a fixed interlock roller and an interlock unlocking roller that is spaced rearward from the fixed interlock roller in the horizontal direction, and wherein the elevator car is detected in the door landing zone in response to interaction between the rearward vane and the interlock unlocking roller.

In addition to one or more of the features described herein, or as an alternative, the elevator car door interlock further comprises having the rearward vane define a first slot and a second slot that are spaced apart from each other in the vertical direction, and wherein the first linkage assembly includes a first intermediate link and a first link, wherein: the first intermediate link is movably connected to the rearward vane through a first pivot pin that extends into the rearward vane and a first pin that extends into the first slot; and the first pin facilitates the first intermediate link moving along the horizontal direction between a rearward slot end and a forward slot end of the first slot, and facilitates pivoting of the first intermediate link relative to the rearward vane.

In addition to one or more of the features described herein, or as an alternative, the elevator car door interlock further comprises having the first link extend between the first intermediate link and the forward vane, and wherein the first link includes a first arm and a second arm, and wherein: the first arm is pivotally connected to the first intermediate link through a first arm pivot; and the second arm is pivotally connected to the forward vane at a first connection and is operably connected to a belt drive.

In addition to one or more of the features described herein, or as an alternative, the elevator car door interlock further comprises the second linkage assembly including a second intermediate link and a second link, and wherein the second intermediate link is movably connected to the rearward vane through a second pivot pin and a second pin, and wherein: the second pivot pin extends into the rearward vane; the second pin extends into the second slot; and the second pin facilitates the second intermediate link moving along the horizontal direction between a rearward slot end and a forward slot end of the second slot, and facilitates pivoting of the second intermediate link relative to the rearward vane.

In addition to one or more of the features described herein, or as an alternative, the elevator car door interlock further comprises having the second link extend between the second intermediate link and the forward vane, and wherein the second link includes a first arm and a second arm, and wherein: the first arm is pivotally connected to the second intermediate link; the second arm is pivotally connected to the forward vane.

In addition to one or more of the features described herein, or as an alternative, the elevator car door interlock further comprises latch assembly including a lock member, the door latch, and a latch link, and wherein: the lock member interfaces with the door latch to inhibit elevator car doors from moving from a closed position towards an open position; and the lock member includes the switch which is configured to: provide a signal indicative of the elevator car doors being in the closed position, while the door latch engages the lock member; and provide a signal indicative of the elevator car doors being in an open or unlocked position, while the door latch is disengaged from the lock member.

In addition to one or more of the features described herein, or as an alternative, the elevator car door interlock further comprises having the latch link extend between the door latch and the first intermediate link, and wherein the latch link is connected to the first intermediate link through a first link pivot and is connected to the door latch through a second link pivot such that the door latch selectively engages the lock member in response to the latch link pivoting with the first intermediate link.

An illustrative example method includes: providing a landing door interlock including a set of rollers are supported by a bracket assembly that is fixed at an associated landing door, wherein the set of rollers comprise a fixed interlock roller and an interlock unlocking roller that is spaced rearward from the fixed interlock roller in a horizontal direction; providing an elevator car door interlock mounted for movement with an elevator car, the elevator car door interlock including: a forward vane mounted for movement with an elevator car and extending in a vertical direction; a rearward vane spaced axially aft from the forward vane in the horizontal direction; at least a first linkage assembly coupling the forward vane and rearward vane together; a latch assembly having a door latch that is coupled to the first linkage assembly; a switch positioned forward of the forward vane in the horizontal direction and facing downward in the vertical direction; and a switch contact supported by the door latch to engage the switch in a locked position and disengage from the switch in an unlocked position; and wherein the method further includes at least one of: pivoting the door latch upwardly from underneath the switch to move the switch contact into engagement with the switch; detecting the elevator car in an associated door landing zone in response to interaction between the rearward vane and the interlock unlocking roller.

In addition to one or more of the features described herein, or as an alternative, the method may include pivoting the door latch upwardly from underneath the switch to move the switch contact into engagement with the switch; and detecting the elevator car in an associated door landing zone in response to interaction between the rearward vane and the interlock unlocking roller.

The various features and advantages of an example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates selected portions of an elevator system.

FIG. 2 is a plan view of an elevator car in an elevator hoistway while the elevator car doors and the landing doors are in a closed position and a car door interlock is in a locked position.

FIG. 3 is a plan view of an elevator car in an elevator hoistway while the elevator car doors and the landing doors are in an open position and the car door interlock is in an unlocked position.

FIG. 4A schematically illustrates a landing door interlock in an unlocked configuration.

FIG. 4B schematically illustrates a corresponding elevator door interlock in an unlocked configuration.

FIG. 5A schematically illustrates the landing door interlock of FIG. 4A in a locked configuration.

FIG. 5B schematically illustrates the corresponding elevator door interlock of FIG. 4B in a locked configuration.

### DETAILED DESCRIPTION

Some embodiments of this disclosure provide an elevator door system with an elevator door interlock that utilizes an electrical switch to confirm a door latch is engaged when a switch contact on a door latch pivots upwardly to contact a downward facing switch. Some embodiments of this disclosure provide an elevator door system where a sensing vane mechanism cooperates with a landing door interlock unlocking roller to detect that an elevator is within a door landing zone.

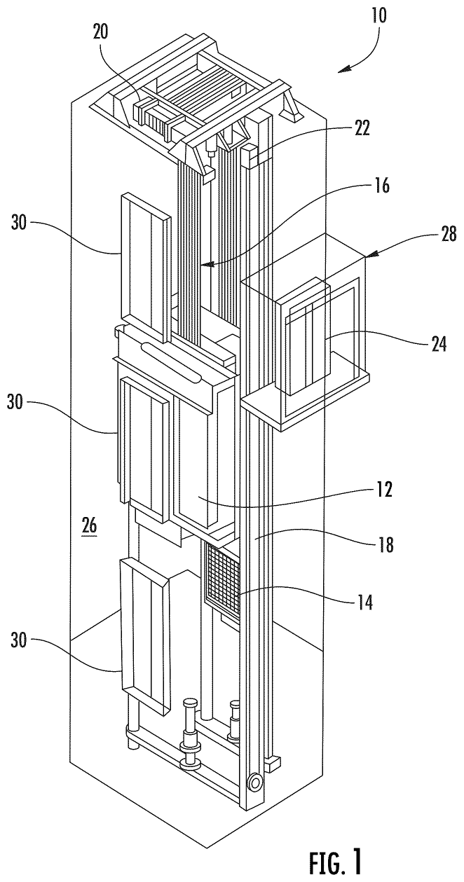

FIG. 1 is a perspective view of an elevator system 10 including an elevator car 12, a counterweight 14, a tension member 16, a guide rail 18, a machine 20, a position reference system 22, and a controller 24. The elevator car 12 and counterweight 14 are connected to each other by the tension member 16. The tension member 16 may include or be configured as, for example, ropes, steel cables, and/or coated-steel belts. The counterweight 14 is configured to balance a load of the elevator car 12 and is configured to facilitate movement of the elevator car 12 concurrently and in an opposite direction with respect to the counterweight 14 within an elevator shaft or hoistway 26 and along the guide rail 18.

The tension member 16 engages the machine 20, which is part of an overhead structure of the elevator system 10. The machine 20 is configured to control movement between the elevator car 12 and the counterweight 14. The position reference system 22 may be mounted on a fixed part at the top of the elevator hoistway 26, such as on a support or guide rail, and may be configured to provide position signals related to a position of the elevator car 12 within the elevator hoistway 26. In other embodiments, the position reference system 22 may be directly mounted to a moving component of the machine 20, or may be located in other positions and/or configurations as known in the art. The position reference system 22 can be any device or mechanism for monitoring a position of an elevator car and/or counter weight, as known in the art. For example, without limitation, the position reference system 22 can be an encoder, sensor, or other system and can include velocity sensing, absolute position sensing and the like, as will be appreciated by those of skill in the art.

According to an aspect and as illustrated in FIG. 1, the controller 24 is located in a controller room 28 of the elevator hoistway 26. The controller 24 may be configured to control the operation of the elevator system 10, and particularly the elevator car 12. For example, the controller 24 may provide drive signals to the machine 20 to control, for example, the acceleration, deceleration, leveling, stopping and the like, of the elevator car 12. The controller 24 may also be configured to receive position signals from the position reference system 22 or any other desired position reference device. When moving up or down within the elevator hoistway 26 along guide rail 18, the elevator car 12 may stop at one or more landings 30 as controlled by the controller 24. Although shown in a controller room 28, those of skill in the art will appreciate that the controller 24 can be located and/or configured in other locations or positions within the elevator system 10. In one embodiment, the controller may be located remotely or in the cloud.

The machine 20 may include a motor or similar driving mechanism. In accordance with embodiments of the disclosure, the machine 20 is configured to include an electrically driven motor. The power supply for the motor may be any power source, including a power grid, which, in combination with other components, is supplied to the motor. The machine 20 may include a traction sheave that imparts force to tension member 16 to move the elevator car 12 within the elevator hoistway 26.

Although shown and described with a roping system including tension member 16, elevator systems that employ other methods and mechanisms of moving an elevator car within an elevator shaft may employ embodiments of the present disclosure. For example, embodiments may be employed in ropeless elevator systems using a linear motor to impart motion to an elevator car. Embodiments may also be employed in ropeless elevator systems using a hydraulic lift to impart motion to an elevator car. FIG. 1 is merely a non-limiting example presented for illustrative and explanatory purposes.

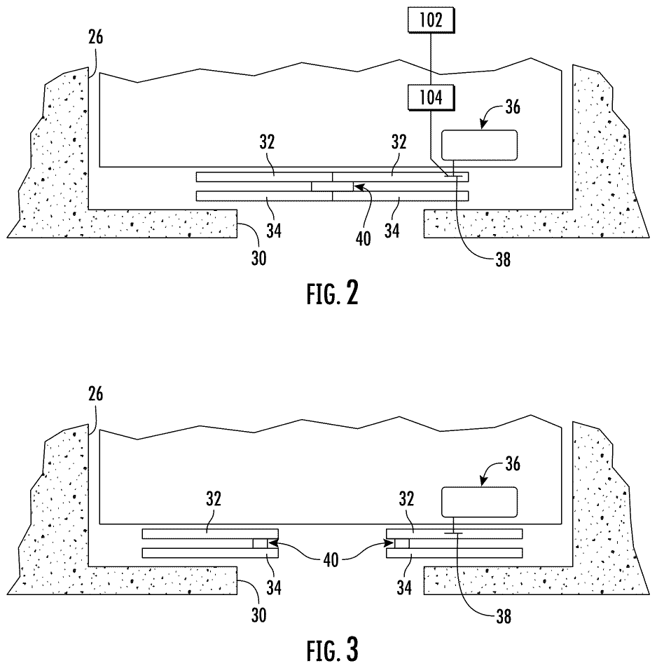

In FIGS. 2 and 3, the elevator car 12 of the elevator system 10 is shown in plan view within the elevator hoistway 26. The elevator car 12 includes a pair of movable elevator car doors 32 and corresponding movable landing doors 34. The elevator car doors 32 and/or the movable landing doors 34 are moved between a closed position, as shown in FIG. 2, and an open position, as shown in FIG. 3, by a drive mechanism 36 having a belt drive 38. The elevator car doors 32 are inhibited from moving between the closed position and the open position when the elevator car 12 is between landings 30 by a car door interlock 40 that is operatively connected to the elevator car doors 32. The elevator car doors 32 are enabled to move between the closed position and the open position by the car door interlock 40 while the elevator car 12 is at a landing 30 or within a landing zone/unlocking zone.

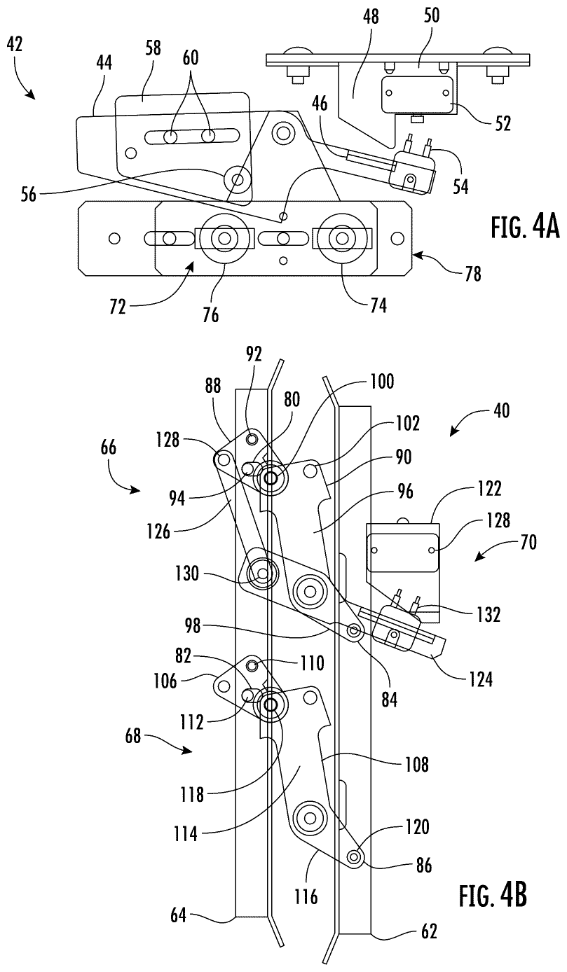

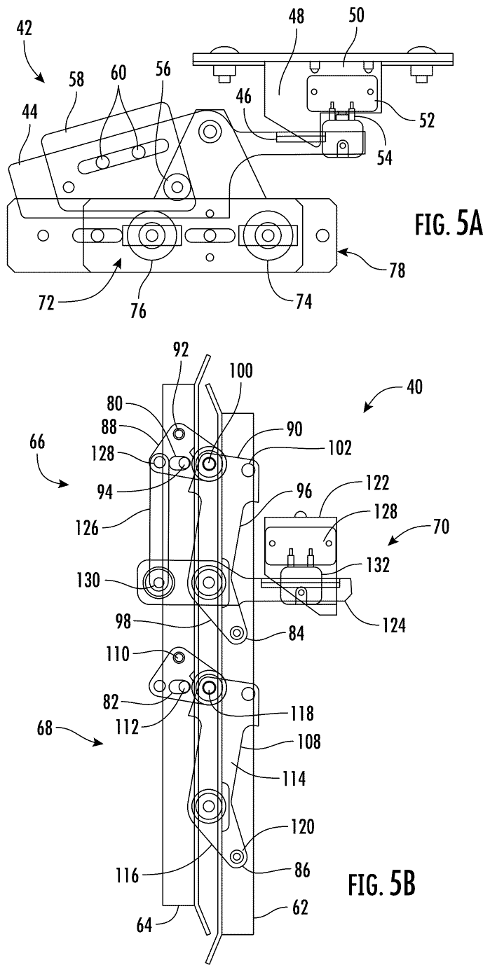

In one example, the car door interlock 40 cooperates with a landing door interlock 42 that is moveable between an unlocked position (FIG. 4A) and a locked position (FIG. 5A). FIG. 4B shows the car door interlock 40 in an unlocked position and FIG. 5B shows the car door interlock a locked position.

In some implementations, the landing door interlock 42 includes a lock 44 that is moveable between a locking position (shown in FIG. 5A) and an unlocked position (shown in FIG. 4A). A locking surface at one end of a slot 46 on the lock 44 engages a stop 48 on a door latch 50 when the lock 44 is in the locking position. In the unlocked position shown in FIG. 5A, the locking surface of the slot 46 is clear of the stop 48 and the landing door 34 is free to move with the elevator car door 32.

The latch 50 includes a switch 52. A switch contact 54 supported on the lock 44 cooperates with the switch 52 to provide an indication when the lock 44 is in the locking position. The switch 52 works in a known manner to provide an indication when a corresponding elevator car door is unlocked based on a lack of contact between the switch 52 and the switch contact 54 as shown, for example, in FIG. 4A.

In some implementations, an unlocking roller 56 is supported on a bracket 58 that is secured to the lock 44. In this example, one or more fasteners 60 secure the bracket 58 in a selected position relative to the lock 44.

In some implementations, landing door interlock 42 is compatible with an elevator door coupler that comprises the car door interlock 40. For example, the landing door interlock 42 may be utilized with a car door interlock 40 that has vanes that move apart or expand to engage the landing door interlock 42 for coordinated movement of the landing door 34 and the elevator car door 32.

Referring to FIGS. 4B and 5B, the car door interlock 40 includes a forward vane 62, a rearward vane 64, a first linkage assembly 66, a second linkage assembly 68, and a latch assembly 70.

In some implementations, the forward vane 62 and the rearward vane 64 are disposed on a baseplate (not shown) on the elevator car door 32 for movement relative to each other. The forward vane 62 and the rearward vane 64 each extend along a vertical axis that is disposed parallel to a direction of travel of the elevator car 12.

In some implementations, the subject disclosure uses the vanes as a sensing mechanism that interacts with a set of rollers 72 (FIGS. 4A and 5A) to detect when the elevator car 12 is within a door landing zone. In one example, the landing door set of rollers 72 may include a fixed front interlock roller 74, a landing door interlock roller 76, and the unlocking roller 56. The rollers 72, 74 are supported by a bracket assembly 78 that is fixed at the landing door 34.

In some implementations, the subject disclosure uses the vanes as a sensing mechanism to detect the landing door interlock roller 76 to indicate that the elevator 12 is within the door zone. Moving the sensing to the landing door interlock roller 76 eliminates any undesirable door motion that may occur during coupling and uncoupling of the car door 32 and landing door 34. For example, any pre-mature movement of the car door 32 may be eliminated because once the rearward vane 64 hits the interlock roller 76 there is no reaction until the system starts to drive the door.

In some implementations, the rearward vane 64 defines a first slot 80 and a second slot 82. The first slot 80 is a generally elongated slot that extends between a forward slot end and a rearward slot end along a horizontal axis. The second slot 82 is axially spaced apart from the first slot 80 along the vertical axis. The second slot 82 is a generally elongated slot that extends between a forward slot end and a rearward slot end along the horizontal axis.

In some implementations, the rearward vane 64 is arranged to actuate the latch assembly 70 that enables the elevator car doors 32 to move between the closed position and the open position, while the elevator car 12 is at the landing 30. The rearward vane 64 is spaced apart from the forward vane 62 in the horizontal direction.

In some implementations, the forward vane 62 defines a first pivot 84 and a second pivot 86 that is axially spaced apart from the first pivot 84 along the vertical axis.

In some implementations, the first linkage assembly 66 includes a first intermediate link 88 and a first link 90. The first intermediate link 88 is movably connected to the rearward vane 64 through a first pivot pin 92 and a first pin 94. The first pivot pin 92 extends into the rearward vane 64. The first pin 94 extends into the first slot 80. The first pin 94 facilitates the first intermediate link 88 moving along the horizontal axis between the rearward slot end and the forward slot end of the first slot 80, and facilitates the pivoting or rotating of the first intermediate link 88 relative to the rearward vane 64.

In some implementations, the first link 90 is pivotally connected to the baseplate and extends between the first intermediate link 88 and the forward vane 62. The first link 90 includes a first arm 96 and a second arm 98. The first arm 96 is pivotally connected to the first intermediate link 88 through a first pivot 100. The second arm 98 includes a first connection to the forward vane 62 at the first pivot 84 to pivotally connect the second arm 98 to the forward vane 62. In one example, this connection may be a pin.

In some implementations, the second arm 98 is connected to a pawl assembly 102 and is connected to the belt drive 38, through a belt hitch 104 (FIG. 2), such that operation of the belt drive 38 drives or pivots the first link 90 of the first linkage assembly 66 and the second linkage assembly 68 to move the forward vane 62 and the rearward vane 64 relative to each other to move between an open position and a closed position.

The pawl assembly 102 comprises a latching member that prevents the belt drive 38 from back driving the linkage assemblies 66, 68 to move the forward and rearward vanes 62, 64 from moving towards the closed position from the open position. One example of a pawl assembly 102 is known from U.S. Pat. No. 11,254,542, which is assigned to same assignee as the subject application, and which is incorporated herein in its entirety. Other types of pawl assemblies may also be used. Further, any type of belt hitch may also be used. Those skilled in the art who have the benefit of this description will be able to determine a pawl assembly and belt hitch combination that would be applied for these purposes.

In some implementations, the second link assembly 68 includes a second intermediate link 106 and a second link 108. The second intermediate link 106 is movably connected to the rearward vane 64 through a second pivot pin 110 and a second pin 112. The second pivot pin 110 extends into the rearward vane 64. The second pin 112 extends into the second slot 82. The second pin 112 facilitates the second intermediate link 106 moving along the horizontal axis between the rearward slot end and the forward slot end of the second slot 82, and facilitates the pivoting or rotating of the second intermediate link 106 relative to the rearward vane 64 and/or the baseplate.

The second link 108 is pivotally connected to the baseplate and extends between the second intermediate link 106 and the forward vane 62. The second link 108 includes a first arm 114 and a second arm 116. The first arm 114 is pivotally connected to the second intermediate link 106 through a second pivot 118. The second arm 116 includes a connection 120 that extends into the pivot 86 to pivotally connect the second arm 116 to the forward vane 62. In one example, the connection 120 may be a pin.

In some implementations, the latch assembly 70 includes a lock member 122, a door latch 124, and a latch link 126. The lock member 122 may be mounted to a car door header (not shown) of the elevator car door 32. The lock member 122 defines a slot or a protrusion that is arranged to interface with the door latch 124 to inhibit the elevator car doors 32 from moving from the closed position towards the open position. The lock member 122 includes a switch 128 that is in communication with the controller 24. The switch 128 provides a signal indicative of the elevator car doors 32 being in the closed position, while the door latch 124 engages the lock member 122. The switch 128 provides a signal indicative of the elevator car doors 32 being in the open or unlocked position, while the door latch 124 is disengaged from or spaced apart from the lock member 122.

In some implementations, the door latch 124 is pivotally connected to the baseplate. In some implementations, the door latch 124 and the first link 90 share the same pivot with that baseplate.

In some implementations, the latch link 126 extends between the door latch 124 and the first intermediate link 88. The latch link 126 is connected to the first intermediate link 88 through a first link pivot 128. The latch link 126 is connected to the door latch 124 through a second link pivot 130. The door latch 124 is arranged to selectively engage the lock member 122 responsive to the latch link 126 pivoting with the first intermediate link 88.

In some implementations, a switch contact 132 supported on the door latch 124 cooperates with the switch 128 to provide an indication when the latch assembly 70 is in the locking position. The switch 28 works in a known manner to provide an indication when a corresponding elevator car door 32 is unlocked based on a lack of contact between the switch 128 and the switch contact 132 as shown, for example, in FIG. 4B.

In some implementations, the switch 128 is positioned to be facing in a downward direction parallel to the vertical axis.

In some implementations, the switch 128 is positioned forward of the forward vane 62. For example, the switch 128 may be axially spaced from the forward vane 62 in the horizontal direction. This allows the door latch 124 to be pivoted upwardly from underneath the switch 128 to move the switch contact 132 into engagement with the switch 128. By having the switch 128 face a downward direction, the possibility of any debris or water entering the switch 128 is minimized.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. An elevator car door interlock comprising:
a forward vane extending in a vertical direction;
a rearward vane spaced axially aft from the forward vane in a horizontal direction;
a first linkage assembly coupling the forward vane and rearward vane together;
a second linkage assembly coupling the forward vane and rearward vane together, wherein the second linkage assembly is axially spaced from the first linkage assembly in the vertical direction;
a latch assembly having a door latch that is coupled to the first linkage assembly;
a switch positioned forward of the forward vane in the horizontal direction and facing downward in the vertical direction; and
a switch contact supported by the door latch to engage the switch in a locked position and disengage from the switch in an unlocked position.

2. The elevator car door interlock of claim 1, wherein the forward vane and the rearward vane comprise a sensing mechanism that interacts with a set of rollers associated with a landing door interlock to detect when an elevator car is within a door landing zone.

3. The elevator car door interlock of claim 2, wherein the set of rollers are supported by a bracket assembly that is fixed at an associated landing door and comprise a fixed interlock roller and an interlock unlocking roller, and wherein the elevator car is detected in the door landing zone in response to interaction between the rearward vane and the interlock unlocking roller.

4. The elevator car door interlock of claim 3, wherein the fixed interlock roller is axially spaced forward from the interlock unlocking roller in the horizontal direction.

5. The elevator car door interlock of claim 1, wherein the rearward vane defines a first slot and a second slot that are spaced apart from each other in the vertical direction, and wherein the first linkage assembly includes a first intermediate link and a first link, wherein:
the first intermediate link is movably connected to the rearward vane through a first pivot pin that extends into the rearward vane and a first pin that extends into the first slot; and
the first pin facilitates the first intermediate link moving along the horizontal direction between a rearward slot end and a forward slot end of the first slot, and facilitates pivoting of the first intermediate link relative to the rearward vane.

6. The elevator car door interlock of claim 5, wherein the first link extends between the first intermediate link and the forward vane, wherein the first link includes a first arm and a second arm, and wherein:
the first arm is pivotally connected to the first intermediate link through a first arm pivot; and
the second arm is pivotally connected to the forward vane at a first connection and is operably connected to a belt drive.

7. The elevator car door interlock of claim 5, wherein the second linkage assembly includes a second intermediate link and a second link, and wherein the second intermediate link is movably connected to the rearward vane through a second pivot pin and a second pin, and wherein:
the second pivot pin extends into the rearward vane;
the second pin extends into the second slot; and
the second pin facilitates the second intermediate link moving along the horizontal direction between a rearward slot end and a forward slot end of the second slot, and facilitates pivoting of the second intermediate link relative to the rearward vane.

8. The elevator car door interlock of claim 7, wherein the second link extends between the second intermediate link and the forward vane, and wherein the second link includes a first arm and a second arm, and wherein:
the first arm is pivotally connected to the second intermediate link;
the second arm is pivotally connected to the forward vane.

9. The elevator car door interlock of claim 1, wherein the latch assembly includes a lock member, the door latch, and a latch link, and wherein:
the lock member interfaces with the door latch to inhibit elevator car doors from moving from a closed position towards an open position; and
the lock member includes the switch which is configured to:
provide a signal indicative of the elevator car doors being in the closed position, while the door latch engages the lock member; and
provide a signal indicative of the elevator car doors being in an open or unlocked position, while the door latch is disengaged from the lock member.

10. The elevator car door interlock of claim 9, wherein the latch link extends between the door latch and the first linkage assembly.

11. An interlock assembly comprising:
a landing door interlock including a set of rollers are supported by a bracket assembly that is fixed at an associated landing door;
elevator car door interlock including:
a forward vane mounted for movement with an elevator car and extending in a vertical direction;
a rearward vane spaced axially aft from the forward vane in a horizontal direction;
a first linkage assembly coupling the forward vane and rearward vane together;
a second linkage assembly coupling the forward vane and rearward vane together, wherein the second linkage assembly is axially spaced from the first linkage assembly in the vertical direction;
a latch assembly having a door latch that is coupled to the first linkage assembly; a switch positioned forward of the forward vane in the horizontal direction and facing downward in the vertical direction; and
a switch contact supported by the door latch to engage the switch in a locked position and disengage from the switch in an unlocked position; and
wherein the forward vane and the rearward vane comprise a sensing mechanism that interacts with the set of rollers to detect when an elevator car is within a door landing zone.

12. The interlock assembly of claim 11, wherein the set of rollers comprise a fixed interlock roller and an interlock unlocking roller that is spaced rearward from the fixed interlock roller in the horizontal direction, and wherein the elevator car is detected in the door landing zone in response to interaction between the rearward vane and the interlock unlocking roller.

13. The interlock assembly of claim 11, wherein the elevator car door interlock further comprises having the rearward vane define a first slot and a second slot that are spaced apart from each other in the vertical direction, and wherein the first linkage assembly includes a first intermediate link and a first link, wherein:
the first intermediate link is movably connected to the rearward vane through a first pivot pin that extends into the rearward vane and a first pin that extends into the first slot; and
the first pin facilitates the first intermediate link moving along the horizontal direction between a rearward slot end and a forward slot end of the first slot, and facilitates pivoting of the first intermediate link relative to the rearward vane.

14. The interlock assembly of claim 13, wherein the elevator car door interlock further comprises having the first link extend between the first intermediate link and the forward vane, and wherein the first link includes a first arm and a second arm, and wherein:
the first arm is pivotally connected to the first intermediate link through a first arm pivot; and
the second arm is pivotally connected to the forward vane at a first connection and is operably connected to a belt drive.

15. The interlock assembly of claim 14, wherein the elevator car door interlock further comprises the second linkage assembly including a second intermediate link and a second link, and wherein the second intermediate link is movably connected to the rearward vane through a second pivot pin and a second pin, and wherein:
the second pivot pin extends into the rearward vane;
the second pin extends into the second slot; and
the second pin facilitates the second intermediate link moving along the horizontal direction between a rearward slot end and a forward slot end of the second slot, and facilitates pivoting of the second intermediate link relative to the rearward vane.

16. The interlock assembly of claim 15, wherein the elevator car door interlock further comprises having the second link extend between the second intermediate link and the forward vane, and wherein the second link includes a first arm and a second arm, and wherein:
the first arm is pivotally connected to the second intermediate link;
the second arm is pivotally connected to the forward vane.

17. The interlock assembly of claim 16, wherein the elevator car door interlock further comprises latch assembly including a lock member, the door latch, and a latch link, and wherein:
the lock member interfaces with the door latch to inhibit elevator car doors from moving from a closed position towards an open position; and
the lock member includes the switch which is configured to:
provide a signal indicative of the elevator car doors being in the closed position, while the door latch engages the lock member; and
provide a signal indicative of the elevator car doors being in an open or unlocked position, while the door latch is disengaged from the lock member.

18. The interlock assembly of claim 17, wherein the elevator car door interlock further comprises having the latch link extend between the door latch and the first intermediate link, and wherein the latch link is connected to the first intermediate link through a first link pivot and is connected to the door latch through a second link pivot such that the door latch selectively engages the lock member in response to the latch link pivoting with the first intermediate link.

19. A method comprising:
providing a landing door interlock including a set of rollers are supported by a bracket assembly that is fixed at an associated landing door, wherein the set of rollers comprise a fixed interlock roller and an interlock unlocking roller that is spaced rearward from the fixed interlock roller in a horizontal direction;
providing an elevator car door interlock mounted for movement with an elevator car, the elevator car door interlock including:
a forward vane mounted for movement with an elevator car and extending in a vertical direction;
a rearward vane spaced axially aft from the forward vane in the horizontal direction;
at least a first linkage assembly coupling the forward vane and rearward vane together;
a latch assembly having a door latch that is coupled to the first linkage assembly;
a switch positioned forward of the forward vane in the horizontal direction and facing downward in the vertical direction; and
a switch contact supported by the door latch to engage the switch in a locked position and disengage from the switch in an unlocked position; and
wherein the method further includes at least one of:
pivoting the door latch upwardly from underneath the switch to move the switch contact into engagement with the switch;
detecting the elevator car in an associated door landing zone in response to interaction between the rearward vane and the interlock unlocking roller.

20. The method of claim 19, including:
pivoting the door latch upwardly from underneath the switch to move the switch contact into engagement with the switch; and
detecting the elevator car in an associated door landing zone in response to interaction between the rearward vane and the interlock unlocking roller.
